(19) United States
(12) Patent Application Publication
(10) Pub. No.: US 2020/0083772 A1
(43) Pub. Date: Mar. 12, 2020

(54) ROTATING ELECTRIC MACHINE

(71) Applicant: AISIN SEIKI KABUSHIKI KAISHA, Kariya-shi, Aichi-ken (JP)

(72) Inventor: Takahiro SONODA, Kariya-shi, Aichi-ken (JP)

(73) Assignee: AISIN SEIKI KABUSHIKI KAISHA, Kariya-shi, Aichi-ken (JP)

(21) Appl. No.: 16/615,649

(22) PCT Filed: Feb. 23, 2018
(86) PCT No.: PCT/JP2018/006678

§ 371 Date: Nov. 21, 2019

(30) Foreign Application Priority Data
May 25, 2017 (JP) 2017-103203

(51) Int. Cl. H02K 3/52; H02K 1/14

(52) U.S. Cl. CPC H02K 3/522; H02K 2203/06; H02K 1/146

(57) ABSTRACT

A rotating electric machine includes a plurality of windings, and the plurality windings include a first winding in which a jumper wire portion is disposed on one side in a rotational axis direction of an armature core and a second winding in which a jumper wire portion is disposed on the other side in the rotational axis direction of the armature core.

### TECHNICAL FIELD

The present invention relates to a rotating electric machine, and particularly, to a rotating electric machine including a winding which includes a winding portion wound around a plurality of core portions and a jumper wire portion connecting the winding portions to each other.

### BACKGROUND ART

In the related art, a rotating electric machine, which has a winding which includes a winding portion wound around a plurality of core portions and a jumper wire portion connecting the winding portions to each other. For example, this rotating electric machine is disclosed in PTL 1.

PTL 1 discloses a rotating electric machine which includes a plurality of (12) core components which constitute an armature core and are divided in a circumferential direction, and an insulator which is provided to cover the core components. In this rotating electric machine, the insulator includes an insulating portion which covers each divided core component and a connection portion which connects a pair of insulating portions to each other. Specifically, four core components are provided for each phase (U phase, V phase, and W phase). Moreover, when viewed in a rotational axis direction, two of the four core components are disposed on one side with respect to a rotation center, and the remaining two are disposed on the other side with respect to the rotation center. Further, the two core components disposed on one side (the other side) are disposed so as to be adjacent to each other. In addition, the insulating portion which covers the two core components disposed on one side with respect to the rotation center and the insulating portion which covers the two core components disposed on the other side with respect to the rotation center are connected to each other by the connection portion. Moreover, the connection portion has a thin plate shape (band shape), and a hole portion through which a rotating shaft of the rotating electric machine passes is provided in a center portion.

Moreover, the rotating electric machine has a winding. The winding includes a winding portion which is wound each divided core component via the insulating portion and a jumper wire portion which connects the winding portions to each other. Specifically, the winding portion wound around the two core components disposed on the one side with respect to the rotation center and the winding portion wound around the two core components disposed on the other side with respect to the rotation center are connected to each other by the jumper wire portion. In addition, the jumper wire portion is disposed in the connection portion so as to bypass a hole portion provided in a center portion of the connection portion of the insulator in a direction (radial direction) perpendicular to the rotational axis direction.

Moreover, a set (armature component unit) including four core components, four insulators, and four windings of each of the U phase, the V phase, and the W phase is combined along the rotational axis direction. Accordingly, the core components of each phase are disposed to be arranged in the circumferential direction to constitute an annular armature core. Moreover, the connection portions (jumper wire portions) of the U-phase, V-phase, and W-phase are disposed to be stacked along the rotational axis direction on an inner diameter side (and an upper side of the armature core) of the annular armature core. In addition, a thin plate-like connection portion is disposed between the jumper wire portions while the jumper wire portions of each phase are stacked along the rotational axis direction. Accordingly, an interference between the jumper wire portions is suppressed by the connection portion.

### CITATION LIST

### Patent Literature

[PTL 1] Japanese Unexamined Patent Application, First Publication No. 2015-92806

### SUMMARY OF INVENTION

### Technical Problem

However, in the rotating electric machine disclosed in PTL 1, the connection portion which suppresses the interference between the jumper wire portions is disposed on an inner diameter side (and on an upper side of the armature core) of the annular armature core. That is, when viewed in the rotational axis direction, the connection portion is disposed so as to straddle the inner diameter-side portion (a portion where a rotor is disposed) of the annular armature core. Accordingly, it is necessary to avoid an interference between the rotor disposed on the inner diameter side of the armature core or a bearing of the rotating shaft and the connection portion. Thereby, there is a problem that a design of the rotating electric machine is restricted.

The present invention is made to solve the above-described problems, and an object of the present invention is to provide a rotating electric machine capable of suppressing the restriction on the design while suppressing the interference between the jumper wire portions.

### Solution to Problem

In order to achieve the object, according to an aspect of the present invention, there is provided a rotating electric machine including: an armature core which includes a plurality of core portions divided in a circumferential direction; and a winding which includes a winding portion wound around the plurality of core portions and a jumper wire portion connecting the winding portions to each other, in which a plurality of the windings are provided to correspond to a plurality of phases, and the plurality of windings includes a first winding in which the jumper wire portion is disposed on one side in a rotational axis direction of the armature core and a second winding which the jumper wire portion is disposed on the other side in the rotational axis direction of the armature core.

In the rotating electric machine according to the aspect of the present invention, the above-described winding is provided. Accordingly, the respective jumper wire portions of the plurality of phases are distributed to the one side of the other side in the rotational axis direction of the armature core. Therefore, unlike a case where the jumper wire portions of the plurality of phases are disposed only on the one side (or only on the other side) in the rotational axis direction of the armature core, the jumper wire portions does not easily interfere with each other. Therefore, unlike PTL 1, interference between the jumper wire portions can be suppressed without providing a connection portion between the jumper wire portions in order to suppress the interference between the jumper wire portions, and thus, there is no restriction on design of the rotating electric machine due to the disposition of the connection portion. As a result, it is possible to suppress the restriction on the design of the rotating electric machine while suppressing the interference between the jumper wire portions.

Moreover, the above-described first winding and second winding are provided. Therefore, it is not necessary to increase a length of one jumper wire portion so as to bypass the other jumper wire portion that the jumper wire portions do not interfere with each other. As a result, an increase in the length of the winding is suppressed, and thereby, an increase in a resistance value of the winding can be suppressed. In addition, it is possible to prevent the length of the rotating electric machine in the rotational axis direction from increasing due to the increase (protrusion in the rotational axis direction) in the length of the winding. Further, since the interference between the jumper wire portions of the respective phases is suppressed, even in a case where the armature core is assembled by moving the plurality of core portions of each phase around which the winding is wound along the rotational axis direction so as to be close to each other, the jumper wire portions of the respective phases do not interfere with each other. Accordingly, it is possible to easily assemble the rotating electric machine (armature core).

In the rotating electric machine according to the aspect, preferably, three windings are provided to correspond to three phases, and the three windings includes the first winding of a first phase, a second winding of a second phase, and a first winding of a third phase.

According to this configuration, the jumper wire portions of the three windings corresponding to the three phases are distributed to the one side and the other side in the rotational axis direction of the armature core. Accordingly, in a three-phase rotating electric machine, it is possible to suppress the restriction on the design of the rotating electric machine while suppressing the interference between the jumper wire portions.

In this case, preferably, in each of the first winding of the first phase and the first winding of the third phase, winding starts from one side in a circumferential direction of the core portion on one end side in a circumferential direction among the plurality of core portions, and the winding ends on the other side in the circumferential direction of the core portion on the other end side in the circumferential direction among the plurality of core portions via the jumper wire portion disposed on the one side in the rotational axis direction, and in the second winding of the second phase, winding starts from one side in the circumferential direction of the core portion on the other end side in the circumferential direction among the plurality of core portions, and the winding ends on the other side in the circumferential direction of the core portion on one end side in the circumferential direction among the plurality of core portions via the jumper wire portion disposed on the other side in the rotational axis direction.

According to this configuration, since winding directions of the first winding and the second winding are the same (for example, the counterclockwise direction) as each other, both of the first winding and the second winding can be formed by one winding device. As a result, it is possible to suppress the interference between the jumper wire portions while preventing a manufacturing device of the rotating electric machine from being complicated.

In the rotating electric machine in which the three windings are provided to correspond to the three phases, preferably, a winding start portion of the first winding of the first phase and a winding end portion of the first winding of the third phase are disposed to extend to the one side in the rotational axis direction from a portion between the adjacent core portions, a winding start portion of the second winding of the second phase and a winding end portion of the first winding of the first phase are disposed to extend to the one side in the rotational axis direction from the portion between the adjacent core portions, and a winding start portion of the first winding of the third phase and a winding end portion of the second winding of the second phase are disposed to extend to the one side in the rotational axis direction from the portion between the adjacent core portions.

According to this configuration, since the winding start portion and the winding end portion of the winding are disposed close to each other. Accordingly, it is not necessary to extend a length of the winding to the vicinity of a terminal in order to connect the winding start portion and the winding end portion of the winding to a terminal or the like. Accordingly, it is possible to prevent the resistance value of the winding from increasing due to the increase in the length of the winding. Moreover, since the winding start portion and the winding end portion of the winding are collected so as to be close to each other, the winding start portion and the winding end portion of the winding can be easily connected to other devices (such as an ECU (engine control unit)).

In the rotating electric machine in which the three windings are provided to correspond to the three phases, preferably, the jumper wire portion of the second winding of the second phase is disposed on a lead wire side, and the jumper wire portions of the first winding of the first phase and the first winding of the third phase are disposed on a side opposite to the lead wire side.

According to this configuration, since only one phase jumper wire portion is disposed on the lead wire side, it is possible to suppress interference between a member disposed on the lead wire side and the jumper wire portion.

In the rotating electric machine according to the aspect, preferably, the jumper wire portion of each of the first winding and the second winding is disposed outside an inner diameter-side surface of the armature core when viewed in the rotational axis direction.

According to this configuration, unlike a case where the jumper wire portion is disposed on inside (rotor side) the inner diameter-side surface of the armature core when viewed in the rotational axis direction, it is possible to prevent interference between the jumper wire portion and the rotor, the rotating shaft, a bearing, or the like disposed inside the inner diameter-side surface of the armature core. Therefore, it is possible to effectively suppress the restriction on the design of the rotating electric machine.

### BRIEF DESCRIPTION OF DRAWINGS

FIG. 1 is a perspective view of a motor (armature core) according to the present embodiment.

FIG. 2 is a perspective view of a winding of each phase.

FIG. 3 is a view showing a connection of the winding of each phase.

FIG. 4 is a view when the armature core according to the embodiment is viewed from a side opposite to a lead wire.

FIG. 5 is a view when the armature core according to the embodiment is viewed from a lead wire side.

FIG. 6 is a side view of the armature core according to the embodiment.

FIG. 7 is a perspective view when the winding of each phase is deployed on a plane.

FIG. 8 is a view for explaining dispositions of the windings of three phases.

FIG. 9 is a view for explaining an assembly method of the armature core.

### DESCRIPTION OF EMBODIMENTS

Hereinafter, an embodiment of the present invention will be described with reference to the drawings.

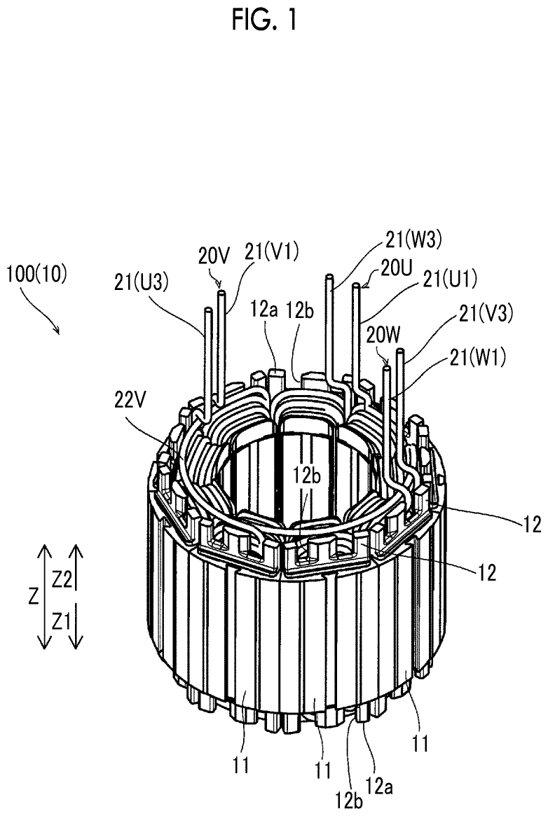

A configuration of a motor 100 (an example of a rotating electric machine) according to the present embodiment will be described with reference to FIGS. 1 to 9.

As shown in FIG. 1, the motor 100 is configured as a brushless motor and includes an armature core 10. The armature core 10 has a plurality of core portions 11 which are divided into a circumferential direction. Specifically, the armature core 10 includes nine core portions 11. In addition, the “circumferential direction” means a circumferential direction of the annular armature core 10.

Moreover, an insulator 12 is provided to cover the core portion 11. The insulator 12 is formed of a resin or the like, and has a function of insulating the windings 20 and the core portion 11 described later. Moreover, a notch 12b is provided in each of one end portion 12a and the other end portion 12a of the insulator 12 in a rotational axis direction. In addition, the “rotational axis direction” means a direction (Z direction) along a rotating shaft of a rotor (not shown).

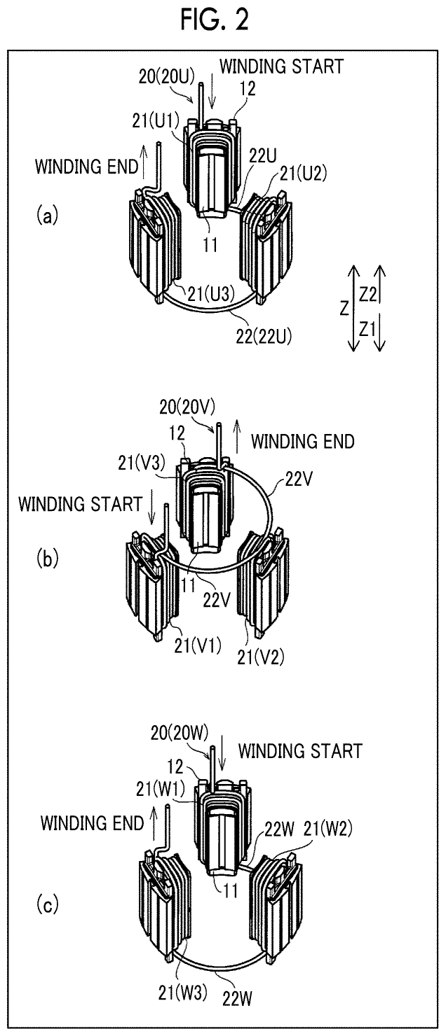

Moreover, as shown in FIGS. 2(a) to 2(c), the motor 100 includes the winding 20. The winding 20 includes a winding portion 21 which is wound around the plurality of core portions 11 and a jumper wire portion 22 which connects the winding portions 21 to each other. Specifically, the winding portion 21 is wound around the core portion 11 a plurality of times via the insulator 12. Moreover, the jumper wire portion 22 is a portion (one conductor) of the winding 20 which connects the winding portions 21 wound a plurality of times.

Moreover, as shown in FIGS. 2(a) to 2(c), the plurality of windings 20 are provided to corresponding to the plurality of phases. Three windings 20 are provided to correspond to three phases. In addition, the three windings 20 include a U-phase (an example of a first phase) winding 20U (an example of a first winding), a V-phase (an example of a second phase) winding 20V (an example of a second winding), and a W-phase (an example of a third phase) winding 20W (an example of a first winding).

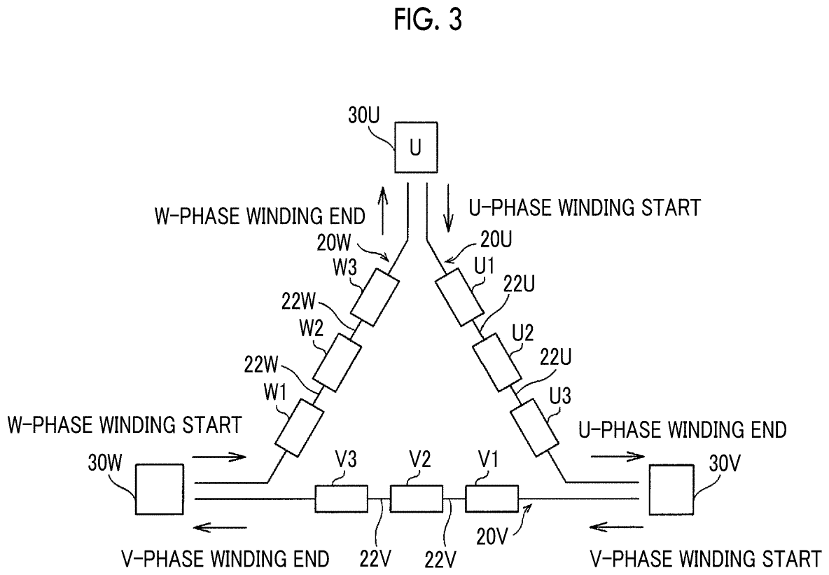

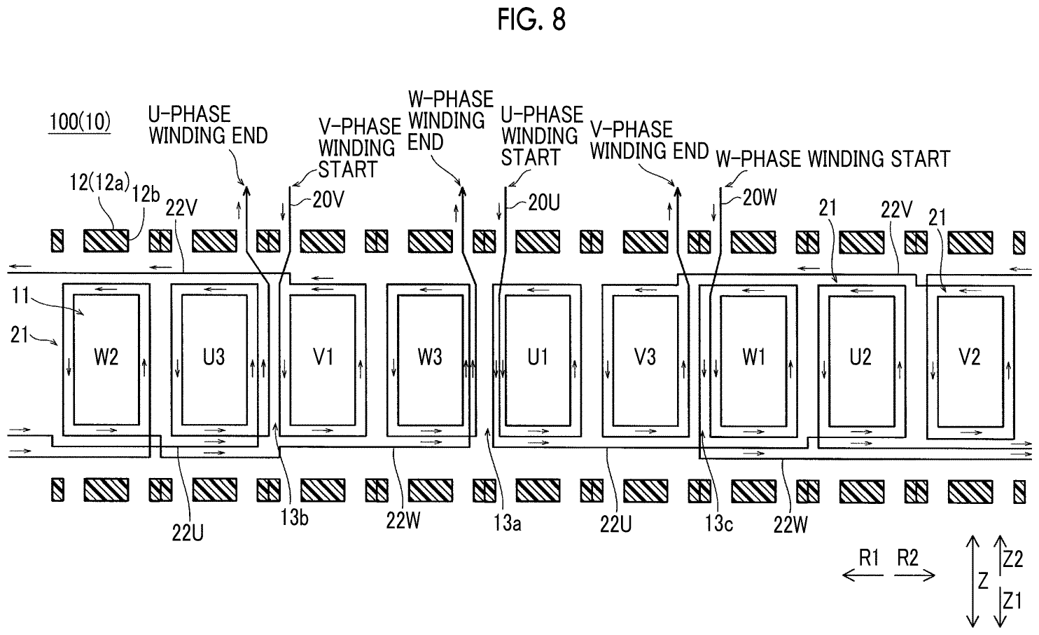

Moreover, as shown in FIG. 3, the winding 20U includes three winding portions 21 (U1, U2, and U3) and two jumper wire portions 22U which connect the winding portions 21 to each other. In addition, the winding 20V includes three winding portions 21V (V1, V2, and V3) and two jumper wire portions 22V which connect the winding portions 21 to each other. Moreover, the winding 20W includes three winding portions 21 (W1, W2, and W3) and two jumper wire portions 22W which connect the winding portions 21 to each other. In addition, the winding 20U, the winding 20V, and the winding 20W are Δ-connected. Specifically, a winding start portion of the winding 20U and a winding end portion of the winding 20W are connected to a terminal 30U. In addition, a winding start portion of the winding 20V and a winding end portion of the winding 20U are connected to a terminal 30V. Moreover, a winding start portion of the winding 20W and a winding end portion of the winding 20V are connected to a terminal 30W. Moreover, a winding direction of the winding portion 21 is the counterclockwise direction (refer to FIG. 8).

Here, in the present embodiment, as shown in FIGS. 2(a) to 2(c), the jumper wire portion 22U (refer to FIG. 2(a)) of the winding 20U and the jumper wire portion 22W (refer to FIG. 2(c)) of the winding 20W are disposed on one side (Z1 direction side) in the rotational axis direction of the armature core 10. In addition, the jumper wire portion 22V (refer to FIG. 2(b)) of the winding 20V is disposed on the other side (Z2 direction side) in the rotational axis direction of the armature core 10. Specifically, the jumper wire portion 22V of the V-phase winding 20V is disposed on a lead wire side. Moreover, the lead wire side is a side (Z2 direction side) on which the winding start portion and the winding end portion of the winding 20 of each phase are disposed. In addition, the jumper wire portion 22U of the U-phase winding 20U and the jumper wire portion 22W of the W-phase winding 20W are disposed on a side (Z1 direction side) opposite to the lead wire side.

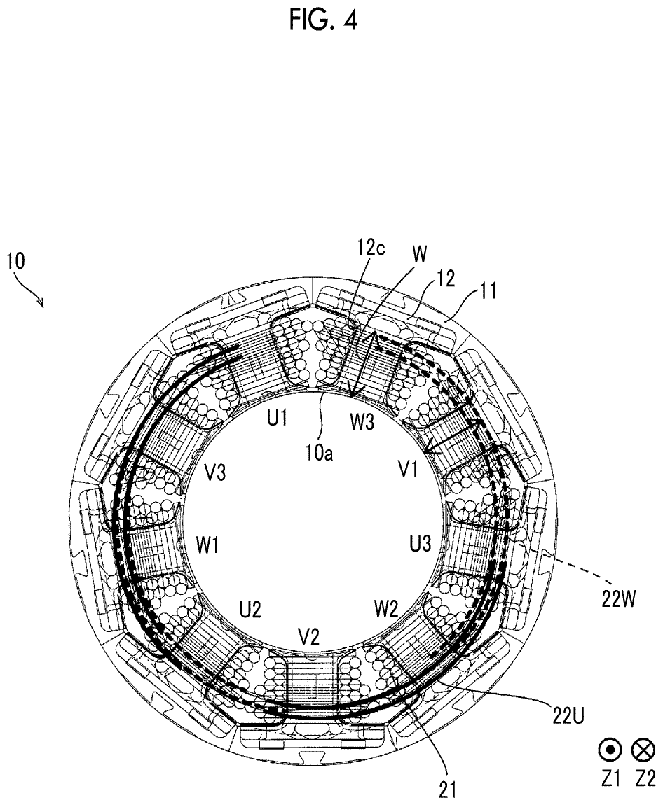

Moreover, in the present embodiment, as shown in FIG. 4, when viewed in the rotational axis direction, the jumper wire portion 22U of the winding 20U is disposed outside an inner diameter-side surface 10a of the armature core 10 (core portion 11). In addition, in FIG. 4, the jumper wire portion 22U is indicated by thick solid lines, and the jumper wire portion 22W is indicated by thick dotted lines. Moreover, in FIG. 4, a cross section of the winding 20 is shown.

As shown in FIG. 4, the jumper wire portion 22U is disposed on the one side (Z1 direction side) of the winding portion 21 in the rotational axis direction. Moreover, when viewed in the rotational axis direction, the jumper wire portion 22U is disposed in an arc shape. Moreover, as shown in FIG. 4, a configuration of the jumper wire portion 22W of the winding 20W is similar to a configuration of the jumper wire portion 22U of the winding 20U. In addition, when viewed in the rotational axis direction, the jumper wire portion 22W of the winding 20W is disposed to be deviated from the jumper wire portion 22U of the winding 20U by a predetermined angular interval (approximately 80°) in the circumferential direction.

Moreover, as shown in FIG. 4, when viewed in the rotational axis direction, the jumper wire portion 22U of the winding 20U and the jumper wire portion 22W of the winding 20W are disposed to partially intersect each other on the one side (Z1 direction side) in the winding portion in the rotational axis direction. In addition, when viewed in the rotational axis direction, the jumper wire portion 22 is configured to be disposed (in width W) between the inner diameter-side surface 10a of the core portion 11 and an inner diameter-side surface 12c of the insulator 12.

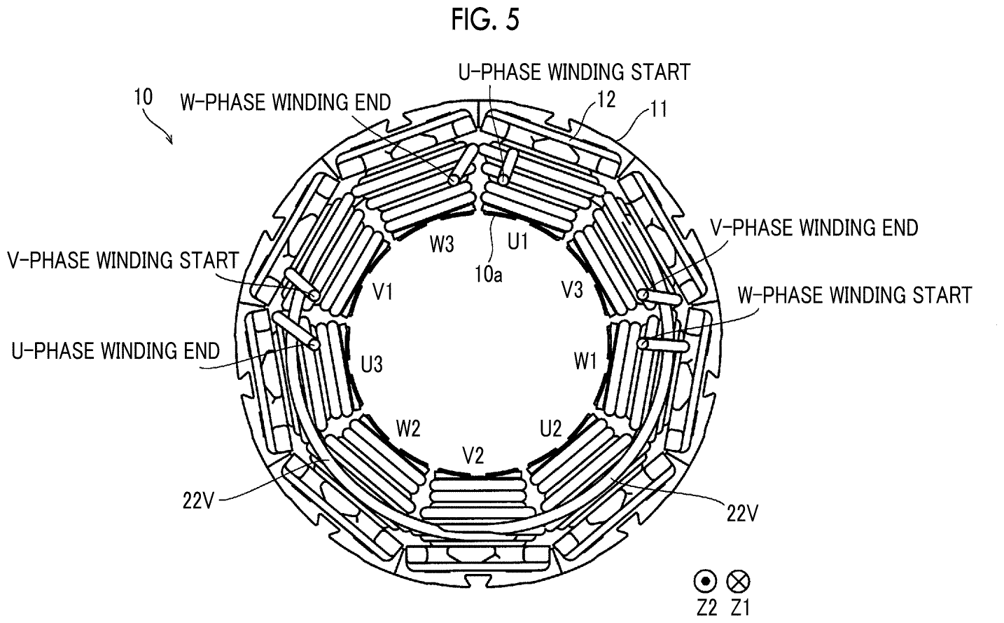

In addition, as shown in FIG. 5, when viewed in the rotational axis direction, the jumper wire portion 22V of the winding 20V is disposed outside the inner diameter-side surface 10a of the armature core 10 (core portion 11). Specifically, the jumper wire portion 22V is disposed on the one side (Z2 direction side) of the winding portion 21 in the rotational axis direction. Moreover, when viewed in the rotational axis direction, the jumper wire portion 22V is disposed in an arc shape.

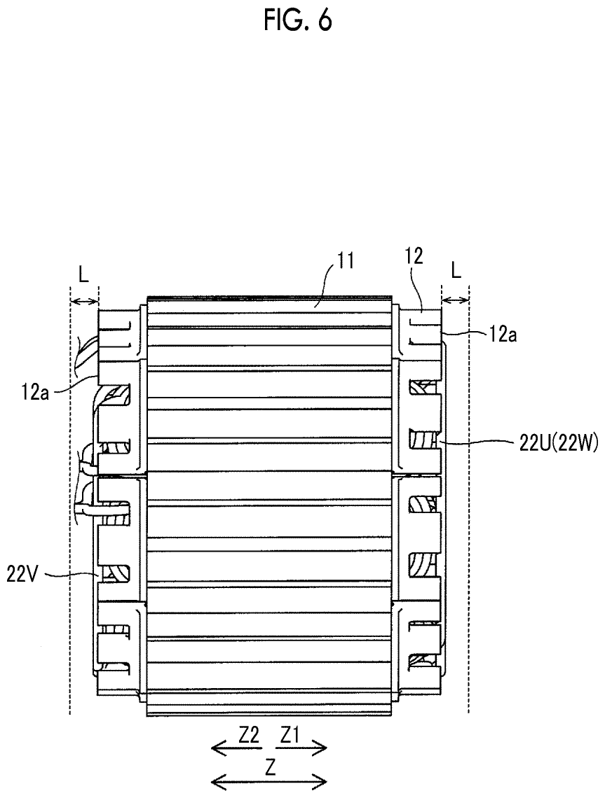

In addition, as shown in FIG. 6, the jumper wire portion 22 (22U, 22V, and 22W) is configured to be disposed to a predetermined distance L from the one end portion 12a (the other end portion 12a) of the insulator 12 in the rotational axis direction.

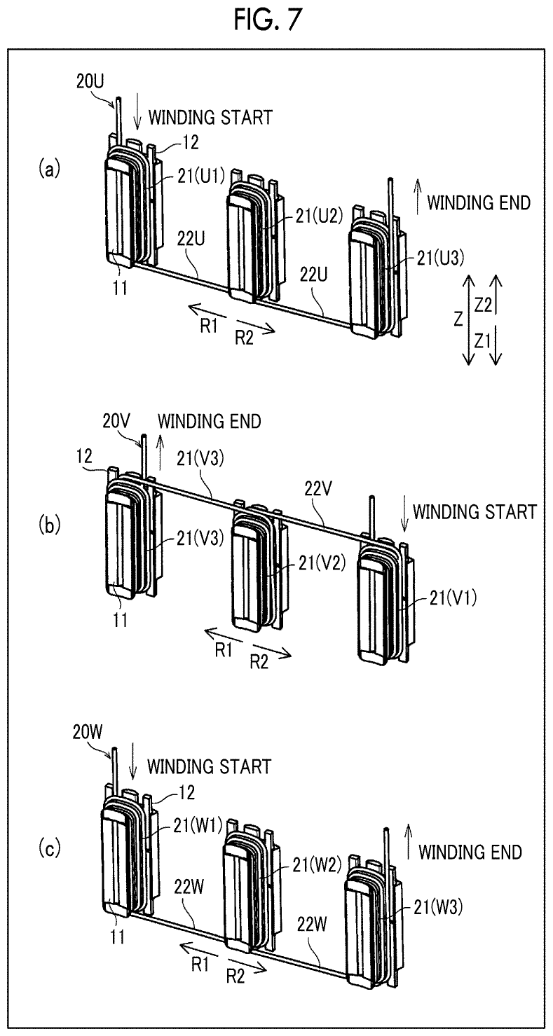

In addition, in the present embodiment, as shown in FIG. 7(a), in the winding 20U, the winding starts from one side (R1 direction side) in the circumferential direction of the core portion 11 on one end side (R1 direction side) in the circumferential direction among the three core portions 11, and the winding ends on the other side (R2 direction side) in the circumferential direction of the core portion 11 on the other end side (R2 direction side) in the circumferential direction among the three core portions 11 via the jumper wire portion 22U disposed on the one side (Z1 direction side) in the rotational axis direction. Specifically, in the winding 20U, the winding starts from the R1 direction side of the core portion 11 disposed on the R1 direction side, the winding portion 21 (U1) is formed, and thereafter, the winding is wound around the center core portion 11 via the jumper wire portion 22U to form the winding portion 21 (U2). Thereafter, the winding 20U is wound around the core portion 11 on the R2 direction side via the jumper wire portion 22U to form the winding portion 21 (U3), and then, the winding 20U ends on the R2 direction side of the core portion 11. In addition, as shown in FIG. 7(c), a configuration the winding 20W is similar to a configuration of the winding 20U.

In addition, as shown in FIG. 7(b), in the winding 20V, the winding starts from one side (R1 direction side) in the circumferential direction of the core portion 11 on the other end side (R2 direction side) in the circumferential direction among the three core portions 11, and the winding ends on the other side (R2 direction side) in the circumferential direction of the core portion 11 on one end side (R1 direction side) in the circumferential direction among the three core portions 11 via the jumper wire portion 22V disposed on the other side (Z2 direction side) in the rotational axis direction. Specifically, in the winding 20V, the winding starts from the R1 direction side of the core portion 11 disposed on the R2 direction side, the winding portion 21 (V1) is formed, and thereafter, the winding is wound around the center core portion 11 via the jumper wire portion 22V to form the winding portion 21 (V2). Thereafter, the winding 20V is wound around the core portion 11 disposed on the R1 direction side via the jumper wire portion 22V to form the winding portion 21 (V3), and then, the winding 20V ends on the R2 direction side of the core portion 11.

In addition, the winding start portion of each of the windings 20 is disposed to extend in the Z2 direction from an inner side (side close to the core portion 11) of the winding portion 21. Moreover, the winding end portion of each of the windings 20 is disposed to extend in the Z2 direction from an outer side (side away from the core portion 11) of the winding portion 21. In addition, the winding start portion (winding end portion) includes an end portion of the winding 20, and a portion (a portion from the end portion to the winding portion 21 wound around the core portion 11) in the vicinity of the end portion.

Moreover, as shown in FIG. 8, the U-phase winding 20U, the V-phase winding 20V, and the W-phase winding 20W are disposed in this order in the circumferential direction. Specifically, the winding portions 21 are disposed in the order of W2, U3, V1, W3, U1, V3, W1, U2, and V2 toward the R2 direction side.

Moreover, in the present embodiment, the winding start portion of the U-phase winding 20W and the winding end portion of the W-phase winding 20W are disposed so as to extend from a portion (slot 13a) between adjacent core portions 11 to the other side (Z2 direction side) in the rotational axis direction. In addition, the winding start portion of the V-phase winding 20V and the winding end portion of the U-phase winding 20U are disposed so as to extend from a portion (slot 13b) between adjacent core portions 11 to the other side in the rotational axis direction. Moreover, the winding start portion of the W-phase winding 20W and the winding end portion of the V-phase winding 20V are disposed so as to extend from a portion (slot 13c) between adjacent core portions 11 to the other side in the rotational axis direction. Moreover, when viewed from the inner diameter side, the winding start portion and the winding end portion of the winding 20 are disposed at a position corresponding to the notch 12b of the insulator 12.

Moreover, as shown in FIG. 5, the winding start portion and the winding end portion of each phase are bent radially inward, and then, bent to extend to the Z2 direction side. Moreover, the winding end portion of the U-phase winding 20U, the winding start portion and the winding end portion of the V-phase winding 20V, and the winding start portion of the W-phase winding 20W are bent so as to avoid the V-phase jumper wire portion 22V.

[Assembly Method of Armature Core]

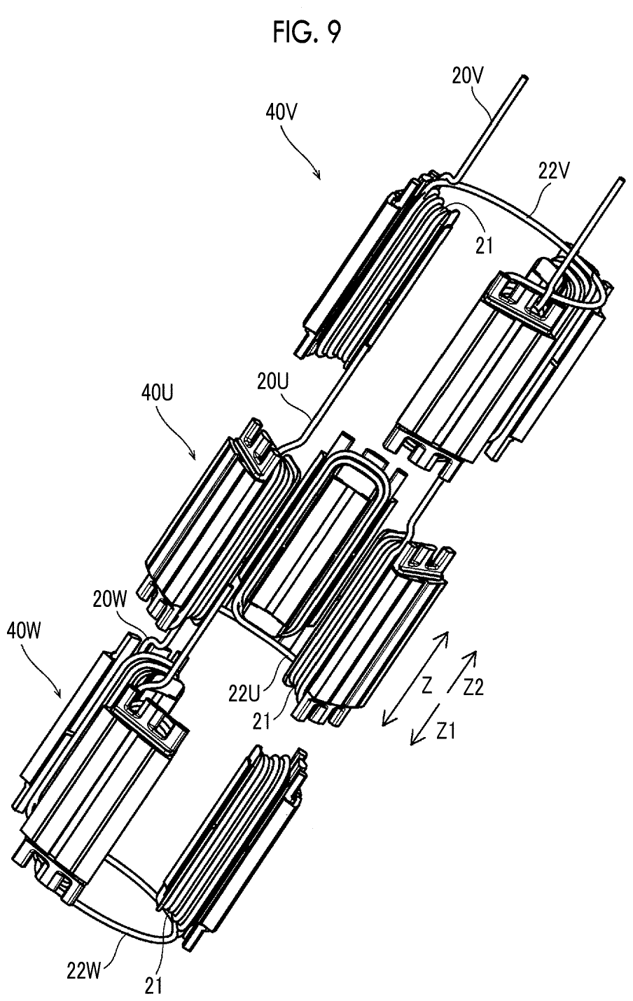

As shown in FIG. 9, three core portions 11 (hereinafter, referred to as a core unit 40V) around which the V-phase winding 20V is wound are disposed in an annular shape (arc shape). In addition, three core portions 11 (hereinafter, referred to as a core unit 40U) around which the U-phase winding 20U is wound are disposed in an annular shape (arc shape). Further, three core portions 11 around which the W-phase winding 20W is wound are disposed in an annular shape (arc shape). In addition, the core unit 40V, the core unit 40U, and the core unit 40W are moved so as to approach each other along the rotational axis direction (Z direction) in a state where the core unit 40V, the core unit 40W, and the core unit 40W are rotated in the circumferential direction relative to each other by approximately 120°. In this case, the core unit 40U and the core unit 40W are assembled to each other so that the W-phase jumper wire portion 22W avoids the U-phase jumper wire portion 22U. Moreover, the V-phase jumper wire portion 22V is disposed on the side (lead wire side) opposite to the U-phase jumper wire portion 22U and the W-phase jumper wire portion 22W, and an interference therebetween is not generated. That is, the V-phase jumper wire portion 22V, the U-phase jumper wire portion 22U, and the W-phase jumper wire portion 22W are respectively disposed to be distributed on the other side (Z2 direction side) and the one side (Z1 direction side) in the rotational axis direction, and thus, it is possible to suppress the interference between the jumper wire portions 22. As a result, it is possible to easily assemble the armature core 10 by moving the core unit 40V, the core unit 40U, and the core unit 40W along the rotational axis direction. Moreover, in a case where the jumper wire portion 22 of each of three phases is disposed only on the one side (or only the other side) in the rotational axis direction of the armature core 10, the W-phase jumper wire portion 22W can be disposed while avoiding the U-phase jumper wire portion 22U. However, when the V-phase jumper wire portion 22V is disposed, the V-phase jumper wire portion 22V interferes with the U-phase jumper wire portion 22U and (or) the W-phase jumper wire portion 22W.

### Effect of the Present Embodiment

In the present embodiment, the following effects can be obtained.

In the present embodiment, the respective jumper wire portions 22 of the plurality of phases are distributed to the one side and the other side in the rotational axis direction of the armature core 10. Accordingly, unlike the case where the jumper wire portions 22 of the plurality of phases are disposed only on the one side (or only on the other side) in the rotational axis direction of the armature core 10, the jumper wire portions 22 does not easily interfere with each other. Therefore, unlike PTL 1, the interference between the jumper wire portions 22 can be suppressed without providing the connection portion between the jumper wire portions 22 in order to suppress the interference between the jumper wire portions 22, and thus, there is no restriction on the design of the motor 100 due to the disposition of the connection portion. As a result, it is possible to suppress the restriction on the design of the motor 100 while suppressing the interference between the jumper wire portions 22.

Further, in the present embodiment, it is not necessary to increase a length of one jumper wire portion so as to bypass the other jumper wire portion 22 so that the jumper wire portions 22 do not interfere with each other. As a result, an increase in the length of the winding 20 is suppressed, and thereby, an increase in a resistance value of the winding 20 can be suppressed. In addition, it is possible to prevent the length of the motor 100 in the rotational axis direction from increasing due to the increase (protrusion in the rotational axis direction) in the length of the winding 20. Further, since the interference between the jumper wire portions 22 of the respective phases is suppressed, even in a case where the armature core 10 is assembled by moving the plurality of core portions 11 of each phase around which the winding 20 is wound along the rotational axis direction so as to be close to each other, the jumper wire portions 22 of the respective phases do not interfere with each other. Accordingly, it is possible to easily assemble the motor 100 (armature core 10).

Moreover, in the present embodiment, the jumper wire portions 22 of the three windings 20 corresponding to the three phases are distributed to the one side and the other side in the rotational axis direction of the armature core 10. Accordingly, in the three-phase motor 100, it is possible to suppress the restriction on the design of the motor 100 while suppressing the interference between the jumper wire portions 22.

Moreover, in the present embodiment, since the winding directions of the winding, 20U, the winding 20W, and the winding 20V are the same (the counterclockwise direction) as each other, all of the winding 20U, the winding 20V, and the winding 20W can be formed by one winding device. As a result, it is possible to suppress the interference between the jumper wire portions 22 while preventing a manufacturing device of the motor 100 from being complicated.

Moreover, in the present embodiment, since the winding start portion and the winding end portion of the winding 20 are disposed close to each other. Accordingly, it is not necessary to extend the length of the winding 20 to the vicinities of the terminal 30U, the terminal 30V, and the terminal 30W in order to connect the winding start portion and the winding end portion of the winding 20 to the terminal 30U, the terminal 30V, and the terminal 30W. Accordingly, it is possible to prevent the resistance value of the winding 20 from increasing due to the increase in the length of the winding 20. Moreover, since the winding start portion and the winding end portion of the winding 20 are collected so as to be close to each other, the winding start portion and the winding end portion of the winding 20 can be easily connected to other devices (such as an ECU (engine control unit)).

Further, in the present embodiment, since only one phase jumper wire portion 22 is disposed on the lead wire side, it is possible to suppress interference between a member disposed on the lead wire side and the jumper wire portion 22.

Moreover, unlike a case where the jumper wire portion 22 is disposed inside (rotor side) the inner diameter-side surface 10a of the armature core 10 when viewed in the rotational axis direction, in the present embodiment, it is possible to prevent interference between the jumper wire portion 22 and the rotor, the rotating shaft, a bearing, or the like disposed inside the inner diameter-side surface 10a of the armature core 10. Therefore, it is possible to effectively suppress the restriction on the design of the motor 100.

### MODIFICATION EXAMPLE

Moreover, the above-described embodiment should be considered as illustrative in all points and not restrictive. The scope of the present invention is shown not by the descriptions of the embodiment but by claims, and further includes all modifications (modification examples) within a meaning and scope equivalent to the scopes of claims.

For example, in the embodiment, the case in which the armature core 10 is divided into nine core portions 11 is described. However, the present invention is not limited to this. For example, the armature core 10 may be divided into a number (for example, a multiple of 3) other than nine.

Moreover, in the embodiment, the example in which three windings 20 are provided to correspond to three phases is described. However, the present invention is not limited to this. For example, the present invention may be applied to a motor 100 having a plurality of phases other than three phases.

Moreover, in the embodiment, the example in which the present invention is applied to the motor 100 is described. However, the present invention is not limited to this. For example, the present invention may be applied to a generator.

Moreover, in the embodiment, the example is described in which the U-phase jumper wire portion 22U and the W-phase jumper wire portion 22W are disposed on the one side (Z1 direction side) in the rotational axis direction and the V-phase jumper wire portion 22V is disposed on the other side (Z2 direction side) in the rotational axis direction. However, the present invention is not limited to this. However, the jumper wire portions of two phases may be disposed on the other side (Z2 direction side) in the rotational axis direction, and the jumper wire portion 22 of one phase may be disposed on the one side (Z1 direction side) in the rotational axis direction.

### REFERENCE SIGNS LIST

10: armature core

11: core portion

20: winding

20U, 20W: winding (first winding)

20V: windings (second winding)

21: winding portion

22, 22U, 22V, 22W: jumper wire portion

100: motor (rotating electric machine)

1. A rotating electric machine comprising:
an armature core which includes a plurality of core portions divided in a circumferential direction; and
a winding which includes winding portions wound around the plurality of core portions and a jumper wire portion connecting the winding portions to each other,
wherein a plurality of the windings are provided to correspond to a plurality of phases, and
wherein the plurality of windings includes a first winding in which the jumper wire portion is disposed on one side in a rotational axis direction of the armature core and a second winding in which the jumper wire portion is disposed on the other side in the rotational axis direction of the armature core.

2. The rotating electric machine according to claim 1,
wherein three windings are provided to correspond to three phases, and
wherein the three windings includes the first winding of a first phase, the second winding of a second phase, and the first winding of a third phase.

3. The rotating electric machine according to claim 2,
wherein in each of the first winding of the first phase and the first winding of the third phase, winding starts from one side in a circumferential direction of the core portion on one end side in a circumferential direction among the plurality of core portions, and the winding ends on the other side in the circumferential direction of the core portion on the other end side in the circumferential direction among the plurality of core portions via the jumper wire portion disposed on the one side in the rotational axis direction, and
wherein in the second winding of the second phase, winding starts from one side in the circumferential direction of the core portion on the other end side in the circumferential direction among the plurality of core portions, and the winding ends on the other side in the circumferential direction of the core portion on one end side in the circumferential direction among the plurality of core portions via the jumper wire portion disposed on the other side in the rotational axis direction.

4. The rotating electric machine according to claim 2,
wherein a winding start portion of the first winding of the first phase and a winding end portion of the first winding of the third phase are disposed to extend to the one side in the rotational axis direction from a portion between the adjacent core portions,
wherein a winding start portion of the second winding of the second phase and a winding end portion of the first winding of the first phase are disposed to extend to the one side in the rotational axis direction from the portion between the adjacent core portions, and
wherein a winding start portion of the first winding of the third phase and a winding end portion of the second winding of the second phase are disposed to extend to the one side in the rotational axis direction from the portion between the adjacent core portions.

5. The rotating electric machine according to claim 2,
wherein the jumper wire portion of the second winding of the second phase is disposed on a lead wire side, and
wherein the jumper wire portions of the first winding of the first phase and the first winding of the third phase are disposed on a side opposite to the lead wire side.

6. The rotating electric machine according to claim 1,
wherein the jumper wire portion of each of the first winding and the second winding is disposed outside an inner diameter-side surface of the armature core when viewed in the rotational axis direction.
